(19) United States
(12) Patent Application Publication
(10) Pub. No.: US 2009/0205498 A1
(43) Pub. Date: Aug. 20, 2009

(54) Air cleaner

(76) Inventors: Chi-Hsiang Wang, Taipei (TW); Yung Ming Tai, Tao-Yaun City (TW)

Correspondence Address: FRANCIS EDWARD MARINO, 394 MEREDITH NECK ROAD, MEREDITH, NH, 03253, US

(21) Appl. No.: 12/030,898

(22) Filed: Feb. 14, 2008

(51) Int. Cl. B01D 46/04; B01D 50/00

(52) U.S. Cl. 95/279; 55/385.1

(57) ABSTRACT

An air cleaning apparatus including a housing defining an airflow passage, a blower retained by the housing and adapted when energized to move air through the airflow passage, a filter element disposed in the airflow passage and having an inlet surface for collecting particulate matter from the airflow. A nozzle element is adapted to engage the inlet surface and is connectable to a vacuum system for allowing the vacuum system to remove the particulate matter collected on the inlet surface. An emitter bathes the inlet surface with radiation to kill germs and detoxify impurities which collect thereon. The filter element is rotated relative to the nozzle element and emitter so that substantially all of the inlet surface is vacuumed and radiated.

### FIELD OF THE INVENTION

This invention relates to household air cleaners, and more specifically, to air cleaners having filters which collect dust and air pollutants, and a means for rejuvenating those filters to reduce the need to replace those filters.

### BACKGROUND OF THE INVENTION

There is an ever-increasing need to provide clean air at home and in the work place. Improved living and work environments are needed, and may be achieved in part by removing harmful contaminants from the air. Airborne pollutants contribute to respiratory infections and illnesses. Without proper air cleaning, individuals are exposed to an ever-increasing level of dust, smoke, pollen, mold spores, bacteria, viruses, animal hair, and soot.

The need to have substantially purified air has resulted in the creation of special filter elements which are defined as HEPA filters. HEPA stands for High Efficiency Particulate Air filters which by, federal standard, are filters with a minimum efficiency of 99.9%. The air cleaning industry defines HEPA filters as those filters which are efficient in removing 99.97% of airborne particles of a size of 0.3 micron or larger.

Although such HEPA filter elements were originally designed for use in ultra clean environments including laboratories, electronic and biologically clean rooms, hospitals and the like, such filters have been used in structures which may be utilized in individual room environments.

Such filters are initially sufficient in their ability to remove particulate matter from the air, but clogging of filter elements in time adversely impacts the efficiency of an air purifier. Consequently, timely replacement of filter elements is critical to prolonged efficient operation. Attempts are made to addressed that problem in numerous prior art air purifiers which providing means for indicating when a clogged filter condition may exist.

Such filters are expensive, and it has been found that even when the need for replacement of a clogged filter is indicated by the air purifier and recognized by those who use them, those users are prone to continue use of these filters long past their recommended lifetimes, and long after they have become clogged and non-functional, to avoid the expense of replacement, and this creates a problem that is hereto unsolved.

There exists the need for an efficient portable room air purifiers which overcomes this problem and reduces the tendency of users to continue using clogged and ineffective filters by providing means for rejuvenating those filters to reduce the need to replace those filters, and such is an object of this invention.

Other needs and objects will become apparent upon a reading of the following disclosure in combination with the appended drawings.

### SUMMARY OF THE INVENTION

The present invention is an air purifier including a housing defining an airflow passage; a blower retained by the housing and adapted when energized to move air through the airflow passage; a filter element disposed in the airflow passage and having an inlet surface for collecting particulate matter from the airflow; The portable air cleaner further includes a nozzle element adapted to engage the inlet surface and connectable to a vacuum system for allowing the vacuum system to remove the particulate matter collected on the inlet surface.

According to one aspect of the invention, one of the nozzle or the filter element is moved relative to the other so that the nozzle engages substantially the entirety of the inlet surface.

According to another aspect of the invention, the inlet surface is cylindrically shaped around a rotational axis, and is rotated around the rotational axis relative to the nozzle to allow the nozzle to engage substantially the entirety of the inlet surface.

According to another aspect of the invention, the nozzle includes a brush engaging the inlet surface to loosen the particulate matter from the inlet surface.

According to an additional aspect of the invention, the brush is vibrated to scrub the particulate matter from the inlet surface.

According to yet another aspect of the invention the air cleaner includes an emitter for bathing the inlet surface with radiation to kill germs and detoxify impurities which collect thereon.

According to yet another aspect of the invention, the filter element is moved relative to the emitter so that the emitter bathes substantially the entirety of the inlet surface.

Additional aspects of the invention can be appreciated upon perusal of the following detailed description of an exemplary air cleaner according to the invention along with the accompanying drawings. The components in the drawings are not necessarily to scale, emphasis instead being placed upon clearly illustrating the principles of the invention. Moreover, in the drawings, like reference numerals designate corresponding parts throughout the several views.

### BRIEF DESCRIPTION OF THE DRAWINGS

FIG. 1 is a perspective view of a portable air cleaner in accordance with an exemplary embodiment of the invention;

FIG. 2 is a front view of the air cleaner of FIG. 1;

FIG. 3 is a partial top view of the air cleaner of FIG. 1 with its cover removed;

FIG. 4 is an exploded perspective view of the air cleaner of FIG. 1;

FIG. 5 is a full front cross section of the air cleaner of FIG. 1 taken at Lines 5-5 of FIGS. 2 and 3;

FIG. 6 is a partial cross section of the air cleaner of FIG. 1 taken at Line 6-6 of FIG. 3;

FIG. 7 is a partial cross section of the air cleaner of FIG. 1 taken at Line 7-7 of FIG. 3;

FIG. 8 is a partial top cross section of the air cleaner of FIG. 1 with its cover removed;

FIG. 9 is a partial cross section of the air cleaner of FIG. 1 with its cover removed and taken at Line 9-9 of FIG. 10;

FIG. 10 is a partial front cross section of the air cleaner of FIG. 1 with the vacuum adapter extended;

FIG. 11 is a full front cross section of the air cleaner of FIG. 1 with the vacuum adapter extended taken at line 11-11 of FIG. 3; and

FIG. 12 is a perspective view showing the vacuum attached to the extended adapter of the air cleaner of FIG. 1.

### DETAILED DESCRIPTION OF THE INVENTION

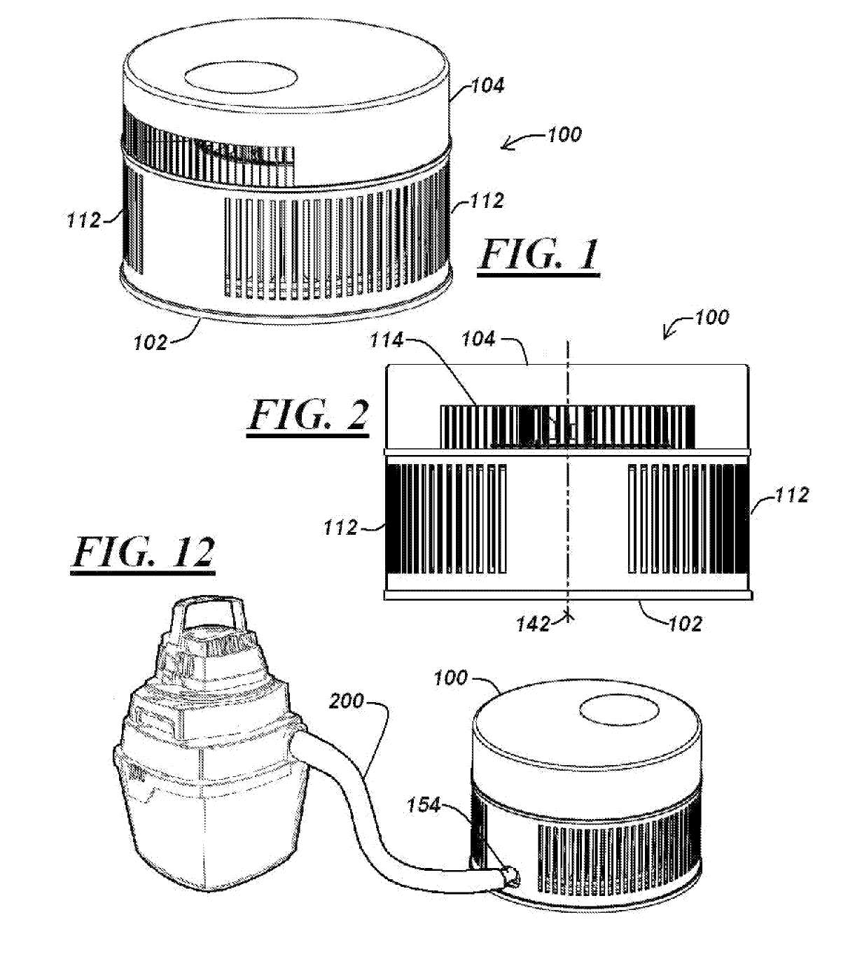

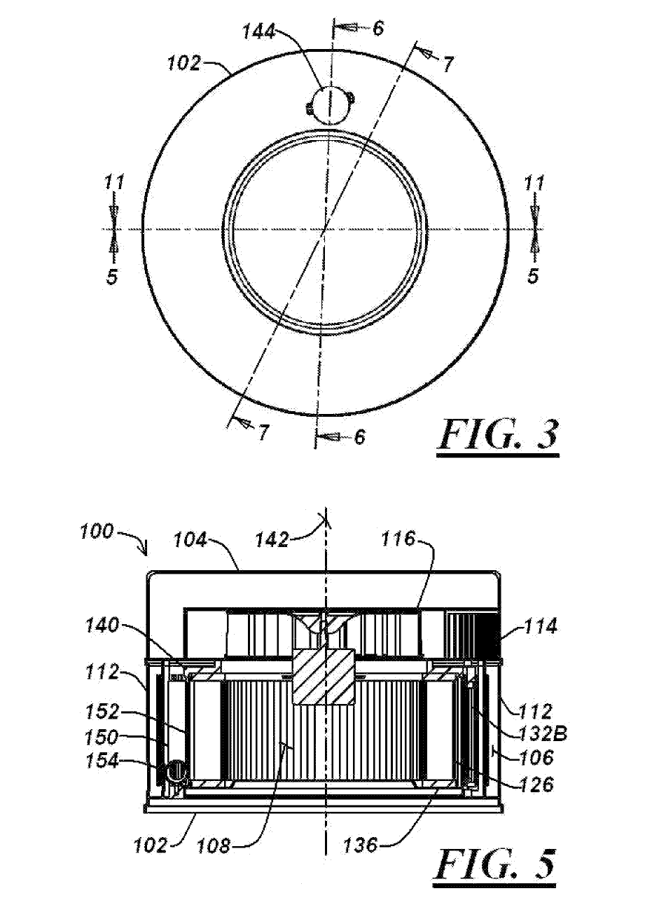

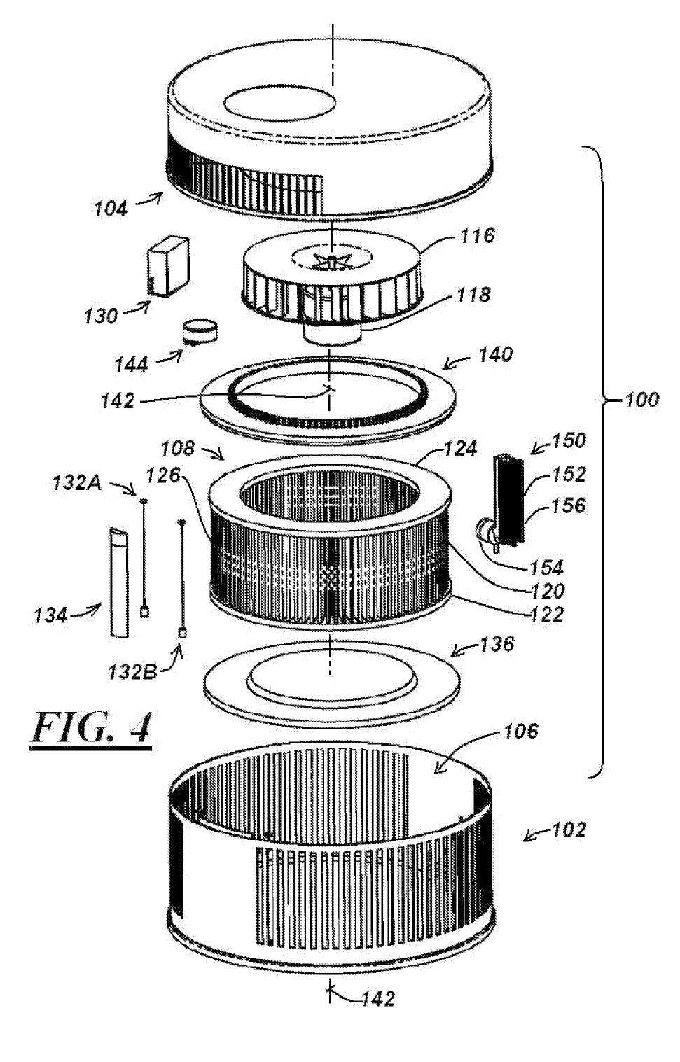

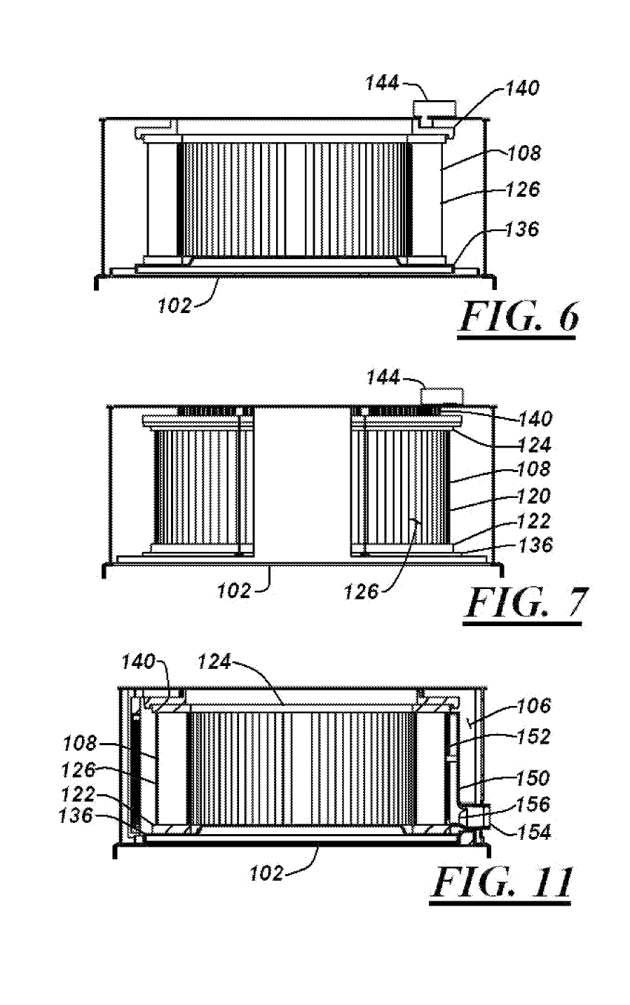

Referring to FIGS. 1 though 12, portable air purifier 100 includes a base 102 and a cover 104, which together form a housing defining a hollow interior chamber 106. Encased in the chamber is a HEPA filter 108.

The housing includes a dirty air intake 112 and a clean air exhaust 114. Supported by the housing and disposed between the intake and exhaust is a blower 116 driven by a high speed motor 118. When the motor is energized, the blower is rotated at high speed to cause an airflow from intake 112, though filter 108, and out of exhaust 114. Such a fan-forced air filtration system could in fact be arranged in accordance with an almost infinite number of prior art configurations.

As shown throughout the figures, filter 108 is a typical cylindrical HEPA filter made of a cylindrically corrugated media 120 sandwiched between annular end caps 122 and 124. Dirty air is pulled first towards the media's inlet surface 126, through the media, to the blower 116, and out through the exhaust 114. Particulate matter filtered from the dirty air collects upon the inlet surface 126. If not removed, such collected particulate matter would ultimately clog the media and retard the filtering ability of the air cleaner.

Also included in the air purifier 100 is a typical ionization system including a high voltage ion generator 130 and a pair of discharge electrodes 132A and 132B. Incoming dirty air is ionized by the ionization system, charging particles that may be too small for mechanical filtration. The filter is oppositely charged, causing the charged particles to be attracted to its inlet surface 126. It can therefore be appreciated that even the finest pollutants are collected on inlet surface 126.

Also included in the air purifier is a vertically disposed ultraviolet lamp 134, which emits ultraviolet radiation onto inlet surface 126 to kill any germs, mold, or such that may be collected thereon, within the zone of the lamp's illumination.

HEPA filter 108 sits atop a rotatable circular support plate 136 within base 102. Fitted atop the filter is a rotatable circular gear ring plate 140. Gear ring plate 140, filter 108, and support plate 136 are rotatable together about a common vertical rotational axis 142.

Fixed to and within the housing is a gear motor 144, which when energized drives gear ring plate 140, filter 108 and support plate 136 slowly in rotation about axis 142.

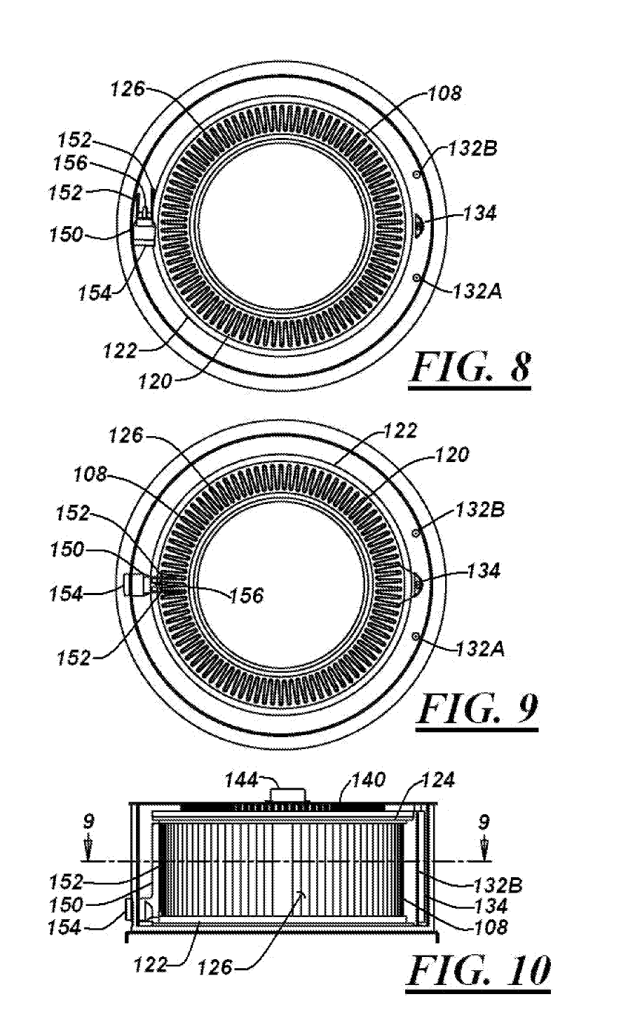

Also fixed to and within the housing is a nozzle element 150 including a brush portion 152 and an adapter portion 154 in pneumatic communication therewith. The adapter portion 154 is connectable to a household vacuum system to pull air from nozzle inlet 156 adjacent brush portion 152, through adaptor portion 154 and into the vacuum system. Nozzle element 150 is movable relative to both the housing and the filter between the storage position of FIGS. 5 and 8, where the adapter portion is retracted within the housing and the brush portion is not in contact with the filter, to the cleaning position of FIGS. 9, 10, 11 and 12, where the adaptor portion extends from the housing for connection to vacuum system 200, and the brush portion engages inlet surface 126. As seen in FIG. 12, during the cleaning position, vacuum system 200 may be connected to the nozzle element and activated to vacuum the particulate matter that has collected on the inlet surface.

During normal operation of the air purifier, as dirty air is being pulled through and filtered by filter 108, filter 108 is preferable stationary. During a selectable cleaning mode, nozzle element 150 is repositioned so that adapter portion 154 protrudes from the air cleaner is and accessible to be connected to a vacuum system. Either a switch may be manually closed to activate motor 144 and UV lamp 134, or else such a switch may be integrated into the nozzle element to cause the energization of motor 144 as the nozzle is moved. Alternatively, the UV lamp may be independently energizable in a separate disinfecting mode.

Upon energization if motor 144 and lamp 134, filter 108 is also caused to slowly rotate relative to lamp 134 so that substantially all of inlet surface 126 is occasionally bathed in ultraviolet radiation and thereby treated. The filter rotation may be continuous at preferably between 0.66 and 0.33 RPM while cleaning, and the filter may be rotated between 1.5 and 3 minutes to ensure that the entire inlet surface 126 has complete at least one rotation relative to the nozzle during cleaning.

Alternatively, the filter may be rotated incrementally in step-by-step fashion, so that the UV lamp may bath stationary angular sections of inlet surface 126, preferably say fifteen angular degrees of the three-hundred and sixty angular degree surface, for preferably 30 seconds per section, while the gear motor and the filter's rotation are paused. Then the filter is rotated to the next angular section and the disinfecting process is repeated for each angular section until the entire surface 126 has been disinfected.

As filter 108 slowly rotates, continuously or incrementally, the nozzle effectively moves along and against inlet surface 126 so that the brush engages substantially the entirety of the inlet surface. Either brush portion 152 or filter 108 may be caused to vibrate during cleaning to cause scrubbing of inlet surface 126 by brush portion 152 for improved cleaning.

Various arrangements of cleaning and disinfecting operation may be alternatively employed according to design preference. For instance, the UV lamp may be only energized while the filter rotation is paused to save lamp life, or the lamp may be energized continuously to simplify circuitry. The brush may be vibrated only during filter rotation or may be energized continuously to simplify circuitry. And an AC power outlet may be provided into which the vacuum system may be plugged, electrically energized to cause the vacuum to run only during filter rotation.

In summary, the invention may be embodied in an air cleaning apparatus having a housing defining an airflow passage, a blower retained by the housing and adapted when energized to move air through the airflow passage, a filter element disposed in the airflow passage and having an inlet surface for collecting particulate matter from the airflow, and a nozzle element adapted to engage the inlet surface.

The nozzle is preferably connectable to a vacuum system for allowing the vacuum system to remove the particulate matter collected on the inlet surface. One of the nozzle and the filter element, preferably the filter element, may be moved relative to the other so that the nozzle engages substantially the entirety of the inlet surface.

The inlet surface may be cylindrically shaped around a rotational axis, and may be rotated around the rotational axis relative to the nozzle to allow the nozzle to engage substantially the entirety of the inlet surface. The nozzle may include an adapter for connection to the vacuum system and a brush for engaging the inlet surface to loosen the particulate matter from the inlet surface. The brush may be vibrated relative to the inlet surface to scrub the particulate matter from the inlet surface.

The nozzle may be movable between a cleaning position wherein the adapter extends from the housing and the brush portion engages the inlet surface and a storage position wherein the adapter is disposed within the housing and the brush portion does not engage the inlet surface.

The air cleaning apparatus may be further embodied with an emitter for bathing the inlet surface with radiation to kill germs and detoxify impurities which collect thereon. One of the emitter and the filter element, preferably the filter element, may be moved relative to the other so that the emitter bathes substantially the entirety of the inlet surface.

Alternatively, the invention may be embodied in an air cleaning apparatus having a housing defining an airflow passage, a blower retained by the housing and adapted when energized to move air through the airflow passage, a filter element disposed in the airflow passage and having a filtration media for collecting particulate matter from the airflow, and an emitter for bathing the filtration media with radiation to kill germs and detoxify impurities which collect thereon, wherein one of the emitter and the filter element, preferably the filter element, is moved relative to the other so that the emitter bathes substantially the entirety of filtration media.

The filtration media surface may be cylindrically shaped around a rotational axis, and may be rotated around the rotational axis relative to the emitter to allow the emitter to bathe substantially the entirety of the filtration media.

Or the invention may be embodied as a method of maintaining one of the afore-described air cleaning apparatuses in which a vacuum system is connected to the nozzle and actuated to remove the particulate matter collected on the inlet surface.

The method may include moving one of the nozzle and the filter element, preferably the filter element, relative to the other so that the nozzle engages substantially the entirety of the inlet surface. Where the inlet surface is cylindrically shaped around a rotational axis, the method may include rotating the inlet surface around the rotational axis relative to the nozzle to allow the nozzle to engage substantially the entirety of the inlet surface.

Where the nozzle includes an adapter for connection to the vacuum system and a brush for engaging the inlet surface to loosen the particulate matter from the inlet surface, the method may further include vibrating the brush relative to the inlet surface to scrub the particulate matter from the inlet surface.

Where the nozzle is movable between a cleaning position wherein the adapter extends from the housing and the brush portion engages the inlet surface and a storage position wherein the adapter is disposed within the housing and the brush portion does not engage the inlet surface, the method may further include moving the nozzle from the storage position to the cleaning position before connecting the vacuum system thereto.

Where the air cleaning apparatus includes an emitter for bathing the inlet surface with radiation to kill germs and detoxify impurities which collect thereon; the method may further include moving the filter element relative to the emitter so that the emitter bathes substantially the entirety of the inlet surface.

Where the filtration media surface is cylindrically shaped around a rotational axis, the method may further include rotating the filter media around the rotational axis relative to the emitter to allow the emitter to bathe substantially the entirety of the filtration media.

From the foregoing, it will be clear that the present invention has been shown and described with reference to a preferred embodiment that merely exemplifies the broader invention revealed herein. Certainly, those skilled in the art can conceive of alternative embodiments. For instance, those with the major features of the invention in mind could craft embodiments that incorporate one or more major features while not incorporating all aspects of the foregoing exemplary embodiment.

Obviously, many modifications and variations of the present invention are possible in light of the above teachings. It is to be understood, therefore, that the invention can be practiced otherwise than as specifically described. With this in mind, the claims that follow will define the scope of protection to be afforded the invention, and those claims shall be deemed to include equivalent constructions insofar as they do not depart from the spirit and scope of the present invention. Certain of these claims may express certain elements as a means for performing a specific function, at times without the recital of structure or material. As the law demands, any such claims shall be construed to cover not only the corresponding structure and material expressly described in the specification but also equivalents thereof.

We claim:

1. An air cleaning apparatus comprising:
a housing defining an airflow passage;
a filter element disposed in said airflow passage and having an inlet surface for collecting particulate matter from the airflow; and
a nozzle element adapted to engage said inlet surface and connectable to a vacuum system for allowing the vacuum system to remove said particulate matter collected on said inlet surface.

2. The air cleaning apparatus of claim 1 wherein one of said nozzle and said filter element is moved relative to the other so that said nozzle engages substantially the entirety of said inlet surface.

3. The air cleaning apparatus of claim 2 wherein said one of said nozzle and said filter element is said filter element.

4. The air cleaning apparatus of claim 3 wherein said inlet surface is cylindrically shaped around a rotational axis, and is rotated around said rotational axis relative to said nozzle to allow said nozzle to engage substantially the entirety of said inlet surface.

5. The air cleaning apparatus of claim 4 wherein said nozzle includes an adapter for connection to the vacuum system and a brush for engaging said inlet surface to loosen said particulate matter from said inlet surface.

6. The air cleaning apparatus of claim 5 wherein said brush is vibrated relative to said inlet surface to scrub said particulate matter from said inlet surface.

7. The air cleaning apparatus of claim 5 wherein said nozzle is movable between a cleaning position wherein said adapter extends from said housing and said brush portion engages said inlet surface and a storage position wherein said adapter is disposed within said housing and said brush portion does not engage said inlet surface.

8. The air cleaning apparatus of claim 7 wherein said brush is vibrated during said cleaning position relative to said inlet surface to scrub said particulate matter from said inlet surface.

9. The air cleaning apparatus of claim 5 further comprising an emitter for bathing said inlet surface with radiation to kill germs and detoxify impurities which collect thereon.

10. The air cleaning apparatus of claim 9 wherein one of said emitter and said filter element is moved relative to the other so that said emitter bathes substantially the entirety of said inlet surface.

11. The air cleaning apparatus of claim 10 wherein said one of said emitter and said filter element is said filter element.

12. An air cleaning apparatus comprising:
a housing defining an airflow passage;
a filter element disposed in said airflow passage and having a filtration media for collecting particulate matter from the airflow; and
an emitter for bathing said filtration media with radiation to kill germs and detoxify impurities which collect thereon; wherein
one of said emitter and said filter element is moved relative to the other so that said emitter bathes substantially the entirety of filtration media.

13. The air cleaning apparatus of claim 12 wherein said one of said emitter and said filter element is said filter element.

14. The air cleaning apparatus of claim 13 wherein said filtration media surface is cylindrically shaped around a rotational axis, and is rotated around said rotational axis relative to said emitter to allow said emitter to bathe substantially the entirety of said filtration media.

15. A method of maintaining an air cleaning apparatus wherein the air cleaning apparatus comprises;
a housing defining an airflow passage;
a filter element disposed in the airflow passage and having an inlet surface for collecting particulate matter from the airflow; and
a nozzle element adapted to engage the inlet surface and connectable to a vacuum system;
the method comprising:
connecting the vacuum system to the nozzle and actuating the vacuum system to remove the particulate matter collected on the inlet surface.

16. The method of claim 15 further comprising:
moving one of the nozzle and the filter element relative to the other so that the nozzle engages substantially the entirety of the inlet surface.

17. The method of claim 16 wherein said moving comprises moving the filter element relative to the nozzle.

18. The method of claim 17 wherein the inlet surface is cylindrically shaped around a rotational axis, and the method further comprises:
rotating the inlet surface around the rotational axis relative to the nozzle to allow the nozzle to engage substantially the entirety of the inlet surface.

19. The method of claim 18 wherein the nozzle includes an adapter for connection to the vacuum system and a brush for engaging the inlet surface to loosen the particulate matter from the inlet surface, and the method further comprises:
vibrating the brush relative to the inlet surface to scrub the particulate matter from the inlet surface.

20. The method of claim 19 wherein the nozzle is movable between a cleaning position wherein the adapter extends from the housing and the brush portion engages the inlet surface and a storage position wherein the adapter is disposed within the housing and the brush portion does not engage the inlet surface: and the method further comprises; moving the nozzle from the storage position to the cleaning position before connecting the vacuum system thereto.

21. The method of claim 20 wherein the air cleaning apparatus further comprises an emitter for bathing the inlet surface with radiation to kill germs and detoxify impurities which collect thereon; and the method further comprises: moving the filter element relative to the emitter so that the emitter bathes substantially the entirety of the inlet surface.

22. A method of maintaining an air cleaning apparatus wherein the air cleaning apparatus comprises;
a housing defining an airflow passage;
a filter element disposed in the airflow passage and having a filtration media for collecting particulate matter from the airflow; and
an emitter for bathing the filtration media with radiation to kill germs and detoxify impurities which collect thereon;
the method comprising:
moving one of the emitter and the filter element relative to the other so that the emitter bathes substantially the entirety of filtration media.

23. The method of claim 22 wherein said moving comprises moving the filter element relative to the emitter.

24. The method of claim 23 wherein the filtration media surface is cylindrically shaped around a rotational axis, and the method further comprises: rotating the filter media around the rotational axis relative to the emitter to allow the emitter to bathe substantially the entirety of the filtration media.
